(19) United States
(12) Patent Application Publication
(10) Pub. No.: US 2025/0124434 A1
(43) Pub. Date: Apr. 17, 2025

(54) CONFIGURING FOREIGN PAYMENT INSTRUMENTS BASED ON TRAVEL TRANSACTIONS

(71) Applicant: American Express Travel Related Services Company, Inc., New York, NY (US)

(72) Inventors: Rajendra Prasad Modadugu, Weston, FL (US); Manjunath B. Devadi, Weston, FL (US); Jyothsna Nayak, Weston, FL (US); Mukund Shankar SimhaRaghu, Glendale, AZ (US)

(21) Appl. No.: 18/486,578

(22) Filed: Oct. 13, 2023

(51) Int. Cl. G06Q 20/40; G06Q 20/38; G06Q 30/0251

(52) U.S. Cl. CPC G06Q 20/4014; G06Q 20/3821; G06Q 30/0269; G06Q 2220/00

(57) ABSTRACT

Disclosed are various embodiments relating to configuring a payment instrument for making foreign purchases in a destination country of an international traveler based at least in part on detecting a transaction for a foreign travel trip. In some examples, the system comprises a computing device that is configured to receive transaction data associated with a user profile. A transaction is identified in the transaction data based at least in part on one or more eligibility criteria. The eligibility criteria can be used to identify that the transaction is for a foreign travel event. Traveler data associated with the transaction is retrieved from a travel computing system. Offer content is generated based at least in part on a comparison between the traveler data and the user profile. Offer content is transmitted to the client device associated with the user profile.

### BACKGROUND

When traveling to another country, individuals obtain funds in the local currency of a destination country in order to make purchases. In some instances, currency exchange services are offered for a fee and the fee can vary significantly based on the currency exchanger provider. As a result, individuals are encouraged to shop around for the best exchange fees, which requires advance planning before traveling to the destination country.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting an example user interface displayed on a client device according to various embodiments of the present disclosure.

FIG. 2 is an example of a network environment according to various embodiments of the present disclosure.

FIG. 3 is a sequence diagram of operations performed in the network environment according to various embodiments of the present disclosure.

FIGS. 4A and 4B are a flowchart illustrating one example of functionality implemented as portions of a service executed in a computing environment in the network environment of FIG. 2 according to various embodiments of the present disclosure.

FIG. 5 is a flowchart illustrating one example of functionality implemented as portions of a service executed in a computing environment in the network environment of FIG. 2 according to various embodiments of the present disclosure.

FIG. 6 is a flowchart illustrating one example of functionality implemented as portions of a service executed in a computing environment in the network environment of FIG. 2 according to various embodiments of the present disclosure.

FIG. 7 is a flowchart illustrating one example of functionality implemented as portions of a service executed in a computing environment in the network environment of FIG. 2 according to various embodiments of the present disclosure.

### DETAILED DESCRIPTION

The various embodiments of the present disclosure relate to configuring a payment instrument for making foreign purchases in a destination country of an international traveler based at least in part on detecting a transaction for a foreign travel trip. For example, the embodiments can be used to detect a transaction completed for an international travel event (e.g., an international flight, an international train trip, an international boating trip) and can configure a payment instrument that can be used in one or more destination locations related to the detected international travel event. The embodiments involve identifying a particular user who is participating in the international travel event and configuring the payment instrument for the identified user, which can be the user making the purchase or another user unaffiliated with the financial account used to make the transaction.

The various embodiments improve the functionality of payment processing systems. For example, the various embodiments can be used to automatically configure a payment instrument to operate at point-of-sale devices in one or more destination countries related to a detected transaction for international travel. In some examples, the embodiments enable a user to configure a payment instrument remotely, with little or no involvement from the purchasing user. Accordingly, the improvements to the payment processing system improve the user experience by reducing the amount of time and user interfaces required for a user to configure a payment instrument for use in a destination country of a purchased international trip.

Further, the various embodiments can improve the security of payment systems by introducing a verification workflow for verifying a user identity prior to delivering a foreign payment instrument. In some implementations, the embodiments can use a decentralized identifier and a verifiable credential to verify the user identity prior to providing the foreign payment instrument. The foreign payment instrument can be delivered as a digital payment instrument or a physical payment instrument. In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples. Accordingly, the security improvements to prevent unauthorized users from accessing a payment instrument during a delivery process. The improvement provide security in local delivery contexts, international delivery context, digital delivery context, and other suitable delivery approaches.

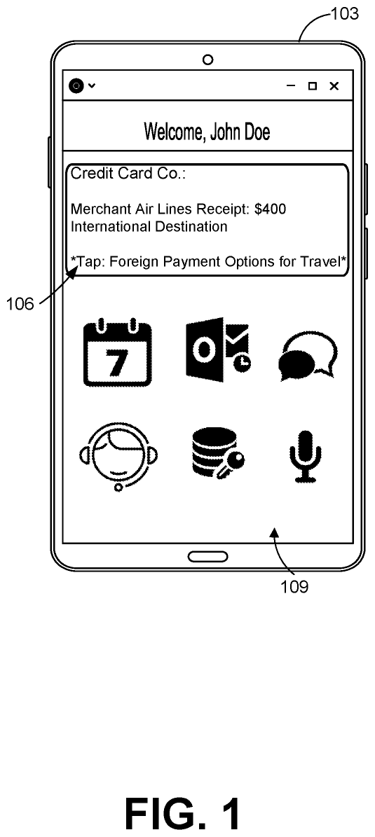

With reference to FIG. 1, shown is a drawing of an example scenario in which a client device 103 receives a transaction notification 106 that allows a user to configure a payment instrument for operating in foreign countries or territories beyond a residential territory or country of the user. In the illustration, the client device 103 has a user interface 109. The transaction notification 106 is received from a remote computing device and displayed over the user interface 109.

In this example, the transaction notification 106 is received as a push notification and the client device 103 is instructed to display the transaction notification 106 as a banner superimposed on the user interface 109. The transaction notification 106 can be received in other wireless manners, such as a short message service (SMS) message (e.g., text messaging), an email message, etc.

The transaction notification 106 can represent a confirmation of a recent transaction based at least in part on a pending charge detected by the remote computing device. In the illustrated example, the transaction has been identified because the transaction involves a purchase of an international flight. As such, the transaction notification 106 includes additional offer content (e.g., foreign payment options) related configuring a foreign payment instrument related to the international destination of the purchased international flight. Thus, the illustrated example illustrates that the user can tap the transaction notification 106 to execute a workflow for configuring a foreign payment instrument that operates at point-of-sale (POS) devices in the destination country and does not cause international fees to be charged for the purchases. As such, the transaction notification 106 can serve as a proactive technique for allowing the purchasing user of the client device 103 to configure a foreign payment instrument soon after the detection of a purchase for the international flight. In some examples, the transaction notification 106 can be generated based at least in part on from a pending charge (e.g., from an authorization code, etc.) generated from a POS device. Thus, the transaction notification 106 can be provided in real-time or near real time after a transaction for an international flight has been completed for a payment instrument of the user.

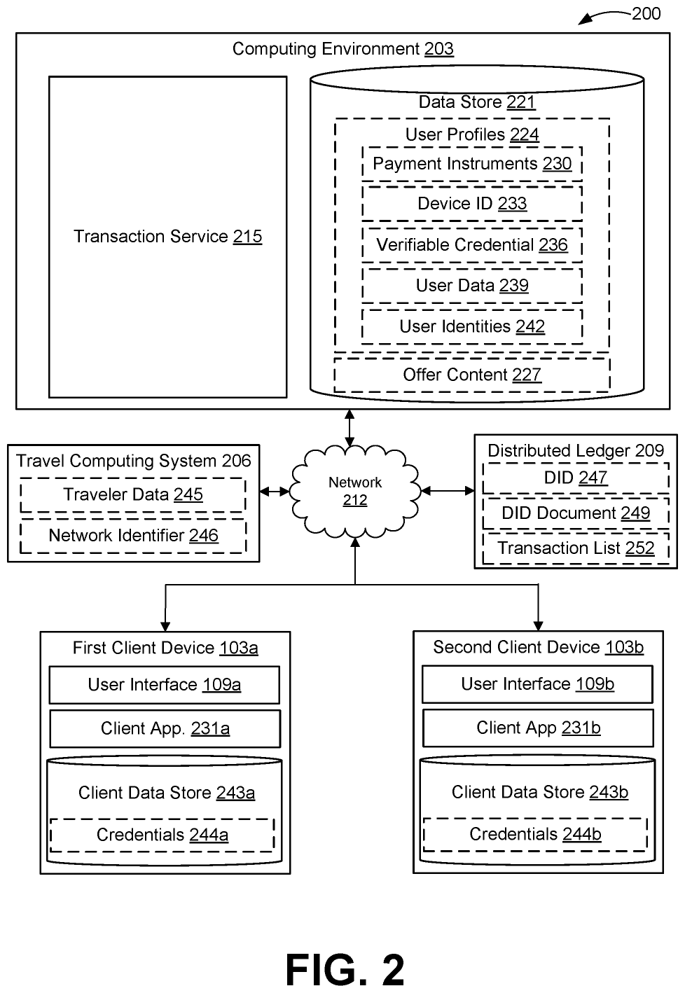

With reference to FIG. 2A, shown is a network environment 200 according to various embodiments. The network environment 200 can include a computing environment 203, a first client device 103a, a second client device 103b (hereinafter generally referred to as “the client devices 103”), a travel computing system 206, and a distributed ledger 209, which can be in data communication with each other via a network 212.

The network 212 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 212 can also include a combination of two or more networks 212. Examples of networks 212 can include the Internet, intranets, extranets, virtual private networks (VPNs), and similar networks.

The computing environment 203 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 203 can employ a plurality of computing devices that can be arranged in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource or any other distributed computing arrangement. In some cases, the computing environment 203 can correspond to an elastic computing resource where the allotted capacity of processing, network, storage, or other computing-related resources can vary over time.

Various applications or other functionality can be executed in the computing environment 203. The components executed on the computing environment 203 include a transaction service 215 and other applications, services, processes, systems, engines, or functionality not discussed in detail herein. The transaction service 215 can be executed to detect travel-related transactions and to facilitate a payment instrument that can operate in one or more foreign countries or territories with respect to an initiate country or territory. The payment instrument can be configured to make purchases without a foreign transaction fee or charge.

Additionally, the transaction service 215 can be executed to verify user identities before delivering the payment instrument. In some examples, the transaction service 215 can issue verifiable credentials that a recipient user can use to verify their user identifier in order to receive the payment instrument. In some embodiments, this functionality can be a part of the computing environment 203 and in other implementations portions of this functionality can be executed in a separate computing environment in combination with the computing environment 203.

Also, various data is stored in a data store 221 that is accessible to the computing environment 203. The data store 221 can be representative of a plurality of data stores 221, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 221 is associated with the operation of the various applications or functional entities described below. This data can include user profiles 224, offer content 227, and potentially other data.

The user profiles 224 can represent data for a user account, a profile, and other suitable profile data. The user profile 224 can include payment instruments 230, a device identifier 233, a verifiable credential 236, user data 239, user identities 242, and other suitable profile data.

The payment instruments 230 can be representative of a physical or digital payment instrument associated with a financial account. The payment instrument 230 can be used by a traveler of a foreign travel event (e.g., an international trip for the traveler) at a destination country or territory. The financial account can be a credit card account, a checking account, a saving account, a gift card account or other suitable financial accounts associated with user profile 224. In the context of the present disclosure, the traveler can also be referred to as a recipient user, who accepts delivery of the payment instrument 230. The traveler (e.g., the recipient user) can be a purchasing user or another individual. The purchasing user can refer to the individual that purchased the foreign travel event for the traveler. For example, a purchasing user can purchase an international flight for their parents or children, and the purchasing user may not be traveling on the international flight. In other examples, the purchasing user can purchase an international flight for themselves.

The payment instruments 230 can be configured to make purchases in one or more destination countries or territories associated with the foreign travel event, without a foreign transaction fee. In some examples, after completing a transaction for the foreign travel event, the user can be presented with an offer for modifying an existing payment instrument 230 to include an international transaction feature. As such, the existing payment instrument 230 can be configured to conduct transactions in countries and/or territories beyond the initial area for the payment instrument 230.

In another example, the payment instrument 230 can represent a foreign or supplemental payment instrument 230 that is linked to a primary payment instrument 230 associated with the user profile 224. For example, the payment instrument 230 can be a second payment instrument 230 for another individual other than the purchasing user of the foreign travel event. The payment instrument 230 can be a physical or digital payment card that is used for conducting transactions in one or more destination locations associated with a recent transaction.

The device identifier 233 can represent an identifier of one of the client devices 103. The device identifier 233 can be a phone number, an internet protocol network address, an international mobile equipment identity (IMEI) number, and other suitable identifiers for client devices 103.

The verifiable credential 236 can represent a tamper-evident credential that has authorship that can be cryptographically verified. Verifiable credentials 236 can be issued by an issuer system. In some examples, the verifiable credential 236 can be issued to a recipient user before receiving the payment instrument 230. A delivery agent can verify an identity of a recipient user before providing the payment instrument 230 to the recipient user.

The user data 239 can represent data associated with a user of the user profile 224. The user data 239 can include a profile identifier, a name, an email address, a demographic, a spending history (e.g., history of travel transactions), a credit history, and other suitable user data. The user data 239 can be used to determine offer content 227.

The user identities 242 can represent data of authorized users to use one or more payment instruments 230. For example, the user identities 242 can include a list of users, such as the user of the user profile, family members, friends, and other suitable individuals. The user identifiers 242 can be generated from individuals that have been added by the user of the user profile 224.

The offer content 227 can represent content data for offers presented to the client device 103 of the purchasing user. The content data can include different payment instrument options related to the foreign travel event. These payment instrument options can be useful for a recipient user (e.g., purchasing user, another individual) to make purchases at a destination country or territory associated with the foreign travel event. In some embodiments, upon detecting a transaction for a foreign travel event, the transaction service 215 can select offer content 227 that includes one or more payment instrument options that can be configured based at least in part on the transaction data and the user profile 224 of the purchasing user. For example, the transaction service 215 can determine that the transaction is for another user other than the user of the user profile 224. As such, the offer content 227 can include one or more payment instrument options for the other individual to make purchases in the destination country of the foreign travel event. In another example, if the international travel transaction is for the purchasing user (e.g., has a user profile 224), then the transaction service 215 can present offer content 227 for one or more foreign payment instrument options for this situation.

The client devices 103 are representative of a plurality of client devices that can be coupled to the network 212. The client devices 103 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, digital video disc (DVD) players, set-top boxes, and similar devices), a videogame console, or other devices with like capability. The client devices 103 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 103 or can be connected to the client device 103 through a wired or wireless connection.

The client devices 103 can be configured to execute various applications such as a client application 231 (representing a first client application 231a and/or a second client application 231b) or other applications. The client application 231 can be executed to facilitate the detection of international travel transactions, and upon detection, configure one or more payment instrument 230 to operate in one or more foreign countries or territories in coordination with the computing environment 203. The configuration of the payment instrument 230 can enable no international fee charges to be applied for transaction made in the destination country. Further, the client application 231 can also be executed in a client device 103 to access network content served up by the computing environment 203 or other servers, thereby rendering a user interface 109 (representing a first user interface 109a and/or a second user interface 109b) on the display. To this end, the client application 231 can include a browser, a dedicated application, or other executable, and the user interface 109 can include a network page, an application screen, or other user mechanism for obtaining user input. The client device 103 can be configured to execute applications beyond the client application 231, such as email applications, social networking applications, word processors, spreadsheets, or other applications.

Also, various data is stored in a client data store 243 (representative of first client data store 243a and/or second client data store 243b) that is accessible to the client device 103. The data stored in the client data store 243 is associated with the operation of the various applications or functional entities described below. This data can include credentials 244 (representative of first credential 244a and/or second credential 244b), and potentially other data. The credentials 244 can be representative of various identity data for payment instruments 230, verifiable credentials 236, and other suitable user data.

The travel computing system 206 can represent a computing environment of a travel merchant (e.g., an airline operator, a boating operator, a train operator, etc.). The travel computing system 206 can be in data communication with the transaction service 215. The travel computing system 206 can include traveler data 245 and a network identifier 246. The traveler data 245 can include traveler names, destination locations, departure locations, and other suitable data related to a foreign travel event for the transaction of the purchasing user. The network identifier 246 can an identifier for the travel computing system 206.

The distributed ledger 209 can represent one or more synchronized, eventually consistent, data stores spread across multiple nodes in different geographic or network locations. The distributed ledger 209 can maintain records of communications (e.g., transactions) between the client devices 103. The distributed ledger 209 can include decentralized identifiers (DIDs) 247, a DID document 249, a transaction list 252, and other suitable data. In various examples, a DID 247 can correspond to an address to a DID document 249 that includes information associated with the subject (e.g., user). For example, the DID document 249 can include a set of data describing the subject and can include various information (e.g., cryptographic keys) that can used to authenticate the subject. In various examples, the DID document 249 can include an address or pathway for accessing a wallet service associated with a user.

The transaction lists 252 can include a record of issued verifiable credentials 236, a record of verified instances, and other suitable data. In various examples, the DID 247, the DID document 249, and the transaction lists 252 can be implemented using various standards, such as the World Wide Web Consortium's (W3C's) Decentralized Identifier (DID) standard.

Next, a general description of the operation of the various components of the network environment 200 is provided. To begin, a purchasing user can make a purchase of a foreign travel event at a travel computing system 206 (e.g., operated by an airline merchant, a boating merchant, a train merchant, etc.). The transaction service 215 can identity the transaction as a foreign travel transaction based at least in part on a set of criteria (e.g., purchase amount, merchant identifier, etc.).

Upon being identified as a foreign travel transaction, the transaction service 215 can request traveler data 245 associated with the foreign travel transaction from the travel computing system 206. The traveler data 245 can include a list of traveler names, departing location, destination locations, and other traveling data.

The transaction service 215 can compare the list of traveler names to name of the purchasing user. The transaction service 215 can determine a type of offer content 227 for a payment instrument 230 based at least in part on whether the purchasing user is a traveler for the foreign traveling event and other travel data. In some embodiments, the transaction service 215 can verify that the foreign travel transaction is indeed for a foreign travel evet based at least in part on a departing location and a destination location indicated in the traveler data 245.

The transaction service 215 can determine offer content 227 for the purchasing user based at least in part on a context associated with the travelers involved with the foreign travel event and a user profile 224 of the purchasing user (e.g., payment instruments 230). After the offer content 227 has been determined, the transaction service 215 can transmit a notification to the client device 103 of the purchasing user. In some examples, the notification can include the offer content 227 and transaction confirmation for the foreign travel event.

The purchasing user can select the notification in order to display a detailed view of the offer content 227 (e.g., one or more options for configuring a payment instrument 230 associated with a country or territory for the foreign travel event). In some examples, the notification can include a deep link for advancing the particular user interface 109 associated with the offer content 227. A deep link can be a type of hyperlink that directs a computing device to a specific client application location (e.g., a specific user interface of the client application). The deep link can save a user the time and energy of locating a particular page and entering data into user interfaces. The deep links can have a uniform resource locator scheme that is associated with a specific client application.

Accordingly, the selection of the notification can cause an execution of an offer workflow associated with the offer content 227. The offer workflow can display one or more user interface 109 for receiving an acceptance of an option associated with the offer content 227. Additionally, the user interface 109 is configured for a selection of a recipient user (e.g., the purchasing user, another user) from a list of travelers associated with the purchased foreign travel transaction and entry of data (e.g., payment restrictions, start date, expiration data, etc.) for configurating a payment instrument 230 for the recipient user.

Subsequently, the transaction service 215 can initiate a delivery of the payment instrument 230 to the recipient user (e.g., the purchasing user, another user user). The recipient user can be selected for data entered during the offer workflow, in which the recipient user is one of the travelers for the foreign travel event. The contact information of the recipient user can be used for delivering the payment instrument 230 to the recipient user.

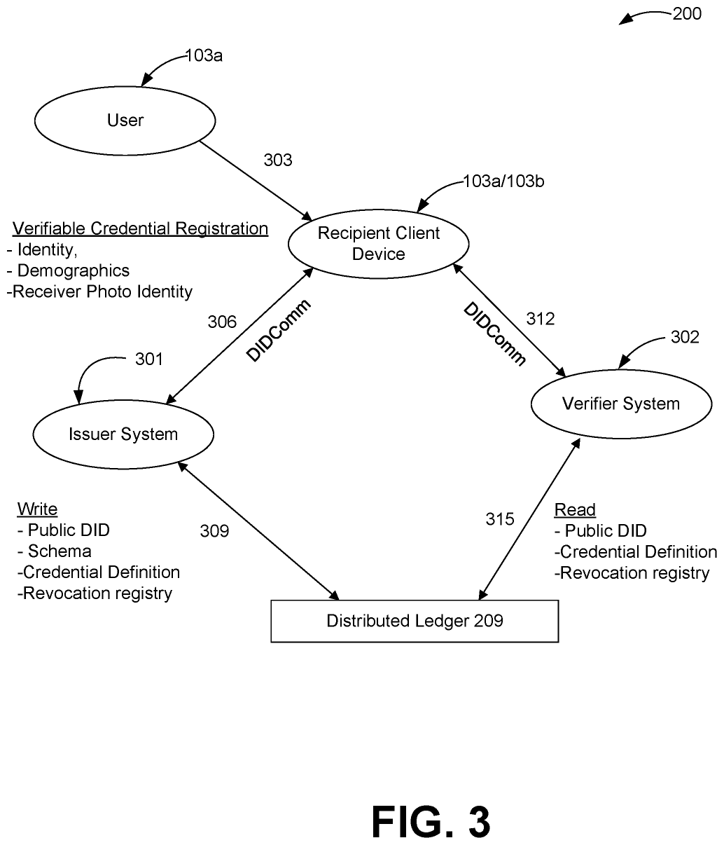

Referring next to FIG. 3, shown is a sequence diagram for a verification workflow of the network environment 200. The verification workflow can be executed to verify a user identity 242 of a recipient user prior to delivering a payment instrument 230. In FIG. 3, the sequence diagram can include a user (e.g., a first client device 103a), a recipient user (e.g., a first client device 103a, a second client device 103b), an issuer system 301 (e.g., a computing environment 203, another computing entity), a verifier system 302 (e.g., a computing environment 203, another computing entity), the distributed ledger 209, and other suitable components. The sequence diagram of FIG. 3 provides merely an example of the many different types of functional arrangements that can be employed to implement the operation of the verification workflow of the networked environment 200. As an alternative, the flowchart of FIG. 3 can be viewed as depicting an example of elements of a method implemented within the network environment 200.

The issuer system 301 can be a computing device that issues verifiable credentials 236 to the recipient client devices 103 of the recipient users. The issuer system 301 can be executed to perform a credential registration process with the recipient client device 103, in which the verifiable credentials 236 can be transmitted to the distributed ledger 209. In some examples, the issuer system 301 is a portion of the computing environment 203. Alternatively, the issuer system 301 can be a separate computing system. The verifier system 302 can be a computing device that verifies an identity of a recipient user before delivering a payment instrument 203 to the recipient user. In some examples, the verifier system 302 can receive a credential (e.g., a verifiable credential 236) from the recipient client device 103 and verify the validating the credential with the distributed ledger 209. If the credential is validated, then the verifier system 302 can deliver the payment instrument 230 to the recipient client device 103 and/or the recipient user. In some examples, the verifier system 302 is a portion of the computing environment 203. Alternatively, the verifier system 302 can be a separate computing system.

At reference 303, the transaction service 215 can initiate a credential registration process between the recipient client device 103 and an issuer system. In some examples, the transaction service 215 can transmit a notification to the recipient client device 103 (e.g., first client device 103a, second client device 103b, etc.). The notification can include a hyperlink or another network identifier for the issuer system 301 and a registration identifier for the recipient user. The recipient user is the intended recipient of the payment instrument 230. The recipient user can be the purchasing user (e.g., who purchased the international travel trip) or the recipient user can be another individual, such as a friend, a family member, a work colleague, or other suitable individual.

At reference 306, a recipient client device 103 can initiate a data session with an issuer system 301 (e.g., which can be the computing environment 203 or a separate computing entity) based at least in part on the notification (e.g., the hyperlink or another network identifier). The data session can be established for initiating a credential registration with the issuer system. The credential registration can be used for issuing a verifiable credential to the recipient client device 103 of the recipient user. The recipient user can use the verifiable credential to verify his or her identity to a verifier system 302 in order to retrieve the payment instrument 230. As part of the credential registration, the issuer system 301 can request identity information, contact information, and/or other suitable data. For example, the requested data can include name, contact information, a photographic identity document, and/or other data suitable. In some examples, the data session is a Decentralized Identifier Communication (DIDComm) between the recipient client device 103 and the issuer system. DIDComm can represent a direct, secure form of communication between owners of DIDs 247. DIDComm can be used to communicate encrypted and authenticated messages between devices with DID 247. The issuer system 301 can determine whether the recipient client device 103 has provided sufficient data for an issuance of a verifiable credential.

At reference 309, the issuer system 301 (e.g., the transaction service 215 in the computing environment 203 or a separate entity) can write the issuance of the verifiable credential to the distributed ledger 209. The insurance can include one or more data elements, such as a public DID, a schema, a credential definition, a revocation registry, and/or other suitable data elements. Upon writing the verifiable credential 236 to the distributed ledger 209, the issuer system 301 can transmit the verifiable credential 236 to the recipient client device 103.

At reference 312, the verifier system 302 (e.g., the transaction service 215 in the computing environment 203, a delivery computing device, or other separate entity) can be executed to verify a user identity 242 of the recipient user seeking a delivery of the payment instrument 230. For example, the verifier system 302 can request a verifiable credential 236 to authenticate the user identity 242 of the recipient user prior to delivery of the payment instrument 230.

The recipient client device 103 can establish a data session the between the recipient client device 103 and the verifier system. The data session can be a DIDComm session or other data session. The recipient client device 103 can transmit the verifiable credential 236 to the verifier system.

At reference 315, the verifier system 302 can verify the user identity 242 of the recipient user at the distributed ledger 209. The verifier system 302 can verify the verifiable credential 236 is authorized to access the payment instrument 230. Upon verifying the user identity 242, the verifier system 302 can deliver the payment instrument 230 to the recipient user. The delivery can involve transmitting a digital payment instrument 230, delivering a physical payment instrument 230, and other suitable options.

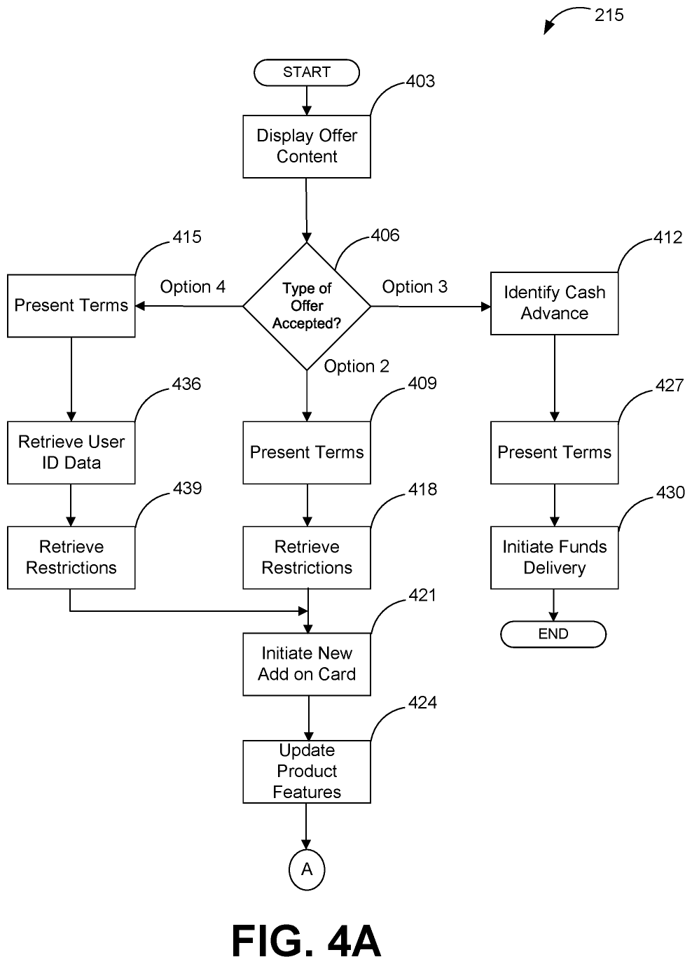

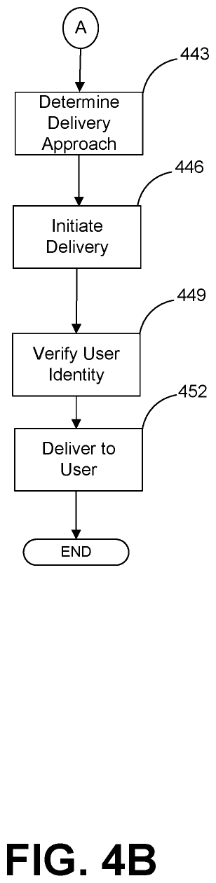

Referring next to FIG. 4A, shown is a flowchart that provides one example of the operation of a portion of the transaction service 215 for processing an acceptance of offer content 227 by a client device 103. The flowchart of FIG. 4A provides merely an example of the many different types of functional arrangements that can be employed to implement the operation of the depicted portion of the transaction service 215. As an alternative, the flowchart of FIG. 4A can be viewed as depicting an example of elements of a method implemented within the network environment 200.

Beginning with block 403, the transaction service 215 can transmit offer content 227 to a client device 103 for display. The offer content 227 can be transmitted based at least in part on a selection of a notification on the client device 103. The transaction service 215 can determine the type of offer content 227 to transmit based at least in part on the user data 239, traveler data 245, and suitable data. For example, a first option of offer content 227 can include displaying information about an international transaction fee-free feature of an existing payment instrument 230 for the user. Accordingly, the first option can include informing the purchasing user of the international transaction fee-free feature of an existing payment instrument 230 already owned by the purchase user.

A second option of offer content 227 can include displaying information about adding an international fee-free feature to an existing payment instrument 230 of the purchasing user or information on issuing a supplemental payment instrument 230 to the purchasing user. In some instances, the addition the international fee-free feature to an existing payment instrument 230 or the issuance of the supplemental payment instrument 230 can be set for use for a limited period of time, which can be set by the purchasing user.

A third option of offer content 227 can include displaying information about a delivery of foreign currency to a residence mailing address of a traveler (e.g., purchasing user or another individual) of the international travel event. The information can include a foreign currency exchange rate for a destination country associated with the international travel event.

A fourth option of offer content 227 can include information for delivering a supplemental payment instrument 230 to another user (e.g., a recipient user) associated with the international travel event. In this fourth option, the supplemental payment instrument 230 is linked to the user profile 224 of the purchasing user. Accordingly, the recipient user (e.g., a traveler) can be provided a supplemental payment instrument 230 and the charges can be applied to a payment instrument 230 or a financial account of the purchasing user. The purchasing user can configure a set of restrictions for the manner in which the supplement payment instrument 230 can be used by the recipient user. Among these options and other possible options, the transaction service 215 can determine which option to transmit to the client device 103.

At block 406, the transaction service 215 can determine which option has been accepted by the client device 103. For example, if option one is selected, then the transaction service 215 can present information about the existing international fee feature on the existing payment instrument 230. If option two is selected, then the transaction service 215 can proceed to block 409. If option three is selected, then the transaction service 215 can proceed to block 412. If option four is selected, then the transaction service 215 can proceed to block 415.

At block 409, the transaction service 215 can transmit terms and conditions related to option two. As previously described, option two can include adding an international feature (e.g., no international fees for purchases made beyond a residential country of a traveler) to an existing payment instrument 230 of the purchasing user or issuing a supplemental payment instrument 230 to the purchasing user. Then, the transaction service 215 can proceed to block 418.

At block 418, the transaction service 215 can receive restrictions for the payment instrument 230 from the client device 103. The restrictions can be received based at least in part on an entry of data in a user interface 109. The restrictions can include a start date, an expiration data, instrument limitations (e.g., transaction types, a transaction limit, country restrictions, etc.), and/or other suitable restrictions.

At block 421, the transaction service 215 can initiate an add-on international transaction feature for an existing payment instrument 230. In some examples, the initiation of the international transaction feature can include modifying a parameter in the data store 221 for an existing payment instrument 230.

Alternatively, in some embodiments, the transaction service 215 can initiate an issuance of a supplemental payment instrument 230 for the purchasing user.

At block 424, the transaction service 215 can update a produce feature of the existing payment instrument 230 to have an international transaction feature. Then, the transaction service 215 can proceed to circle A of FIG. 4A. The remaining portion of the flowchart is shown in FIG. 4B.

At block 412, the transaction service 215 can implement the selection of option three. The implementation can include the transaction service 215 transmitting data (e.g., user interfaces 109) to the client device to generate a cash advance request for a destination country associated with the foreign travel event. Upon a submission of the cash advance request by the client device 103, the transaction service 215 can identify the cash advance request for a currency of one or more destination locations. The cash advance request can include a desired amount and a currency of a destination location for the international travel ticket. For example, if the purchasing user has purchased an international airline ticket from New York City, NY to London, England, then the request can include a requested amount of currency in the British Pound. In another example, if the traveler is an Indian resident that is coming to the United States, then the request can include a requested amount of currency in dollars. Then, the transaction service 215 can proceed to block 427.

At block 427, the transaction service 215 can transmit terms and conditions related to option three. In some examples, the terms and conditions can include a currency exchange rate and other suitable information. The presentation of the terms and conditions can include a request to a select a user interface component for accepting the terms and the conditions. The acceptance of the terms and conditions can be stored in the data store 221.

At block 430, the transaction service 215 can initiate a delivery of the cash advance currency to the recipient user. In some instances, the delivery of the currency involves delivering physical currency. In other instances, the currency is delivery in a digital format. Then, the transaction service 215 can proceed to the end.

At block 415, the transaction service 215 can implement the selection of option four. In this example, the fourth option relates to configuring a payment instrument 230 for another user (e.g., family member, friend, work colleague) other than the purchasing user since the purchasing is not participating in the international travel event. The presentation of the terms and conditions can include a request to a select a user interface component for accepting the terms and the conditions. The acceptance of the terms and conditions can be stored in the data store 221. Then, the transaction service 215 can proceed to block 436.

At block 436, the transaction service 215 can request information for the user identity 242 of the traveler (e.g., a recipient user who is different from the purchasing user). The transaction service 215 can transmit user interface data to the client device 103 for receiving a name, age, mailing address, email address, phone number, and other suitable user identity information of the traveler. The retrieved data can be stored as user identities 242 in the data store 221. In some examples, the transaction service 215 can already have retrieved the name of the traveler based at least in part on traveler data 245 from the travel computing system 206. In this example, the transaction service 215 can retrieve additional user identity information that was not provided.

At block 439, the transaction service 215 can retrieve restrictions for the payment instrument 230. The restrictions can include a start date, an expiration data, a limit on purchase categories (e.g., food, accommodations, travel, school supplies), an aggregated spending limit for the payment instrument 230, and other suitable restrictions. Then, the transaction service 215 can proceed to block 421. The functionality for block 421 was previously described.

Referring next to FIG. 4B, shown is a flowchart that continues the operations of the transaction service 215 from circle A of FIG. 4A. The flowchart of FIG. 4B provides merely an example of the many different types of functional arrangements that can be employed to implement the operation of the depicted portion of the transaction service 215. As an alternative, the flowchart of FIG. 4B can be viewed as depicting an example of elements of a method implemented within the network environment 200.

At block 443, the transaction service 215 can determine the delivery approach for the foreign payment instrument to the recipient user based at least in part on a delivery context associated with the recipient user. The delivery context can indicate whether the delivery of the foreign payment instrument 230 has been configured for digital delivery, for local delivery (e.g., within the country or territory of the purchasing user), for international delivery (e.g., outside of the country or territory of the purchasing user), or other suitable delivery contexts. In the event the payment instrument 230 for another user (e.g., other than purchasing user), the delivery context can be determined from the user identities 242 (e.g., data retrieved from the purchasing user in block 436). The user identities 242 can include a delivery preference, such as digital delivery or physical delivery. The user identities 242 can include contact information for the delivery, such as an email address, a phone number, a mailing address, and/or other suitable contact information of the recipient user.

At block 446, the transaction service 215 can initiate a delivery of the payment instrument 230 based at least in part on the delivery context. For example, if a physical delivery is preferred, then the transaction service 215 can initiate a delivery of a foreign payment card to a local mailing address of the recipient user via a courier. If the mailing address is in another country or territory, then the transaction service 215 can initiate delivery of the foreign payment card with an international courier. If digital delivery is preferred, then the transaction service 215 can transmit data for the payment instrument 230 to the client device 103 of the recipient user. The transmitted data can be directed to a wallet application executed on the client device 103. In other cases, the transmitted data can direct the client device 103 to download a client application 231 (e.g., a wallet application, a mobile application associated with the transaction service 215, etc.) in order to make purchases with the payment instrument 230.

In some examples, the purchasing user is the recipient user. As such, the user data 239 can include contact information for delivering the payment instrument 230 via digital delivery or physical delivery.

At block 449, the transaction service 215 can verify the user identity 242 of the recipient user during delivery. In some embodiments, the transaction service 215 can initiate a verification workflow (e.g., FIG. 3). The verification workflow can involve the transaction service 215 initiating a credential registration for the recipient user. Upon completion of the credential registration, an issuer system 301 can send a verifiable credential 236 to the recipient user.

During a delivery, the transaction service 215 or a delivery agent (e.g., a computing entity or a personal courier) can request the verifiable credential 236 from the recipient user in order to verify the user identity 242 of the recipient user. Upon providing the verifiable credential 236, the transaction service 215 can verify the user identity 242 of the recipient user.

At block 452, the transaction service 215 can deliver the payment instrument 230 to the recipient user based at least in part on the verification of the user identity 242. Then, the transaction service 215 can proceed to the end.

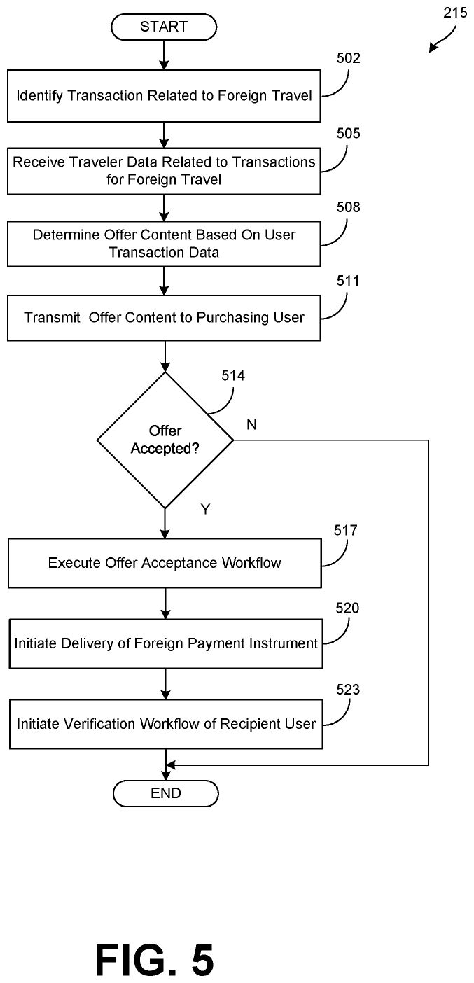

Referring next to FIG. 5, shown is a flowchart that provides an overview example of the operation of a portion of the transaction service 215, in which portions of FIGS. 4A, 4B, 6, and 7 are included. The flowchart of FIG. 5 provides merely an example of the many different types of functional arrangements that can be employed to implement the operation of the depicted portion of the transaction service 215. As an alternative, the flowchart of FIG. 5 can be viewed as depicting an example of elements of a method implemented within the network environment 200.

Beginning with block 502, the transaction service 215 can identify one or more transactions related to a foreign travel event based at least in part on an eligibility criteria and transaction data. The eligibility criteria can identify a foreign travel event that involves transporting a traveler from a first country or territory to a second country or territory. The transaction data can be received from a travel computing system 206. The transaction data can include pending charges, posted charges, or other suitable transaction data. In some examples, a pending charge can be identified from a travel computing system 206. The eligibility criteria can include one or more parameters related to foreign travel events. For example, the location eligibility criteria can include meeting a monetary amount threshold, identifying certain travel merchants are involved in the transactions, a history of previous transactions, identifying the transaction as a travel category, a combination of elements, or other suitable conditions.

The transaction data can be evaluated as to whether it meets the eligibility criteria. For example, the transaction service 215 can identify a transaction from the transaction data. The metadata associated with the transaction can include an amount of $800 and travel category. The $800 amount can exceed a threshold of $600 for potential foreign travel transaction. Additionally, the travel category can be identified as well. The transaction service 215 can identify the transaction as a potential foreign travel transaction based at least in part on these two conditions. Other conditions can be used to identify or filter out potential foreign travel transactions.

At block 505, the transaction service 215 can receive user data 239 associated with the transaction related to foreign travel events. As such, the transaction service 215 can transmit a request for traveler data 245 for transactions that have been identified as potential foreign travel transactions (e.g., for a foreign travel event). In some examples, the transaction service 215 can retrieve the traveler data 245 from the travel computing system 206. The traveler data 245 can include names of the travelers for the foreign travel events. In some examples, the transaction service 215 can send a request to travel computing system 206 by using a network identifier 246 associated with the travel computing system 206. The traveler data 245 (e.g., names, ages, travel data, etc.) can be stored as one or more user identities 242. The network identifier 246 can be identified based at least in part on a merchant identifier associated with the transaction.

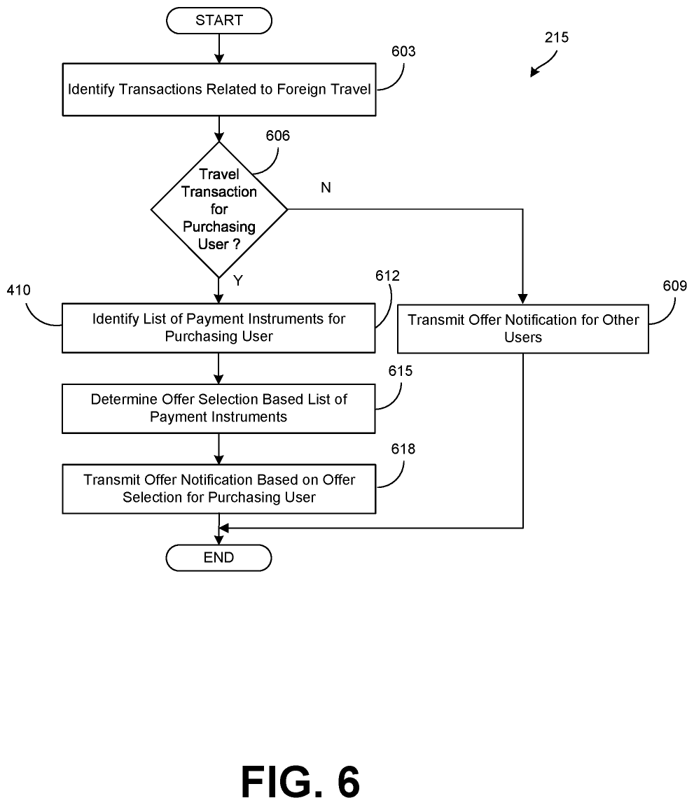

At block 508, the transaction service 215 can determine or identify offer content 227 based at least in part on the traveler data 245 and the user profile 224 (see e.g., FIG. 6). The transaction service 215 can compare the purchasing user of the user profile 224 to names identified from the traveler data 245. If the name of the purchasing user is included in the traveler data 245, then the foreign travel event includes the purchasing user. If the purchasing user is not included in the traveler data 245, then this condition can be a factor for the transaction service 215 in determining the offer content 227. For example, if the purchasing user is not a traveler, then the transaction service 215 can select different offer content 227.

At block 511, the transaction service 215 can transmit the offer content 227 to the client device 103 of the purchasing user based at least in part on the determination of the offer content 227. In some examples, the transaction service 215 can transmit a notification that includes the offer content 227 and a transaction confirmation. In some instances, the offer content 227 can be transmitted with the transaction confirmation in real-time or near-real time shortly after the completion of the purchase (E.g., a push notification, SMS message, etc.). The transaction service 215 can use the device identifier 233 or contact information from the user data 239 to transmit the client device 103 of the purchasing user.

At block 514, the transaction service 215 can determine whether an option for the offer content 227 was accepted. For example, the acceptance can include a selection of a notification or a hyperlink displayed on the client device 103. As previously described in FIGS. 4A and 4B, different options can be presented to the client device 103 of the purchasing user based at least in part on if the purchasing user is a traveler and data in the user profile 224. If the notification is not selected within a threshold time period, then the transaction service 215 can determine the purchasing user has failed to select the offer content 227. Then, the transaction service 215 can proceed to the end. If the purchasing user has selected the offer content 227 (e.g., a selection of an option), then transaction service 215 can proceed to block 517.

At block 517, the transaction service 215 can execute an offer acceptance workflow (e.g., FIGS. 4A and 4B) associated with the selected option. Based on the option of offer content 227 transmitted to the client device 103, the transaction service 215 can determine a particular offer acceptance workflow to execute in response to receiving the indication of the acceptance of the offer content 227 from the client device 103.

At block 520, the transaction service 215 can initiate delivery workflow of the payment instrument 230 to the recipient user (see e.g., FIG. 4B). The delivery workflow can vary based at least in part on a delivery context for the recipient user. The delivery context can indicate who is the recipient user (e.g., purchasing user, other users identified in user identities 242, etc.), the selected delivery approach (e.g., digital delivery, mailing, hand delivery, etc.), the delivery contact information (e.g., email address, phone number, mailing/residence address, etc.), and other suitable delivery data. The delivery context can be determined by the transaction service 215 in various manners. For example, the delivery context can be determined from the traveler data 245 provided from the travel computing system, from user profile 224 (e.g., the user data 239, user identities 242, etc.), and/or from other suitable data sources.

At block 523, the transaction service 215 can initiate a verification workflow during the delivery workflow or prior to the delivery of the payment instrument 230 (e.g., FIG. 3). In some examples, the verification workflow can involve initiating a registration process for the recipient user. After the credential registration is completed, an issuer system 301 (e.g., the transaction service 215 or another computing entity) can issue a verifiable credential 236 to a recipient client device 103 (e.g., first client device 103a, second client device 103b). During delivery of the foreign payment instrument 100 to the recipient user, a verifier system 302 (e.g., the transaction service 215 or another computing entity) can verify if the recipient user has a verifiable credential 236 associated with the payment instrument 230. As such, upon providing the verifiable credential 236, the verifier system 302 can provide the payment instrument 230 to the recipient user. Then, the transaction service 215 can proceed to the end.

Referring next to FIG. 6, shown is a flowchart that provides one example of the operation of a portion of the transaction service 215 for presenting offer content 227 to a client device 103, which relates to FIG. 5 (508). The flowchart of FIG. 6 provides merely an example of the many different types of functional arrangements that can be employed to implement the operation of the depicted portion of the transaction service 215. As an alternative, the flowchart of FIG. 6 can be viewed as depicting an example of elements of a method implemented within the network environment 200.

Beginning with block 603, the transaction service 215 can identify one or more transactions related to a foreign travel event based at least in part on an eligibility criteria and transaction data. The eligibility criteria can identify a foreign travel event that involves transporting a traveler from a first country or territory to a second country or territory. The transaction data can be received from a travel computing system 206. The transaction data can include pending charges, posted charges, or other suitable transaction data. In some examples, a pending charge can be identified from a travel computing system 206. The eligibility criteria can include one or more parameters related to foreign travel events. For example, the location eligibility criteria can include a monetary amount threshold is met, certain travel merchants are involved in the transactions, a history of previous transactions, a combination of elements, and other suitable conditions.

The transaction data can be evaluated as to whether it meets the eligibility criteria. If the transaction data meets the location eligibility criteria, then the transaction service 215 can filter or identity the transaction for further analysis in block 505.

At block 606, the transaction service 215 can determine whether the foreign travel transaction was purchased for the purchasing user (e.g., associated with the payment instrument 230 used for transaction) or another user. For example, after the foreign travel transaction has been identified, the transaction service 215 can retrieve traveler data 245 for the identified foreign travel transaction. The traveler data 245 can include one or more names for travelers participating on the foreign travel event. Additionally, the traveler data 245 can include data on the foreign travel event, such as departure location, destination location, travel dates, method of travel, and other travel related data.

The transaction service 215 can compare the name of the purchasing user to the list of travelers listed in the traveler data 245. If the purchasing user is not in the list of travelers, the transaction service 215 can proceed to block 609. If the purchasing user is in the list of travelers, then the transaction service 215 can proceed to block 612.

In block 609, the transaction service 215 can transmit data for a notification to the client device 103. The notification can include offer content 227 relating to enabling a payment instrument 230 in the context of the foreign travel event being for users other than the purchasing user, in which case the other users can include friends, family members, work colleagues, and other suitable individuals. Since the purchasing user is not traveling, the offer content 227 can be selected based at least in part on this context. Referring to previously described options, in some embodiments, the offer content 227 can include the third option for displaying information about a delivery of foreign currency to a residence mailing address of another user other than the purchasing user for a destination country for the international travel event. The offer content 227 can also include the fourth option for delivering a supplemental payment instrument 230 to the other user associated with the international travel event. In some examples, data can be transmitted to the client device 103 for the display of both of these options. The options can be displayed in association with the user interface components for a user to select the third options or the fourth options. Then, the transaction service 215 can proceed to the end, which effectively equates to waiting for an offer acceptance as described in FIG. 5 (514).

In block 612, the transaction service 215 can identify a list of payment instruments 230 associated with the purchasing user from the user profile 224. The transaction service 215 can identify which of the list of payment instruments 230 have a foreign transaction fee feature. The foreign transaction fee can enable the recipient user to make purchases with little or no fee in a foreign country.

At block 615, the transaction service 215 can determine offer content 227 for transmitting to the client device 103 based at least in part on the list of payment instruments 230 associated with the user profile 224 of the purchasing user has a foreign transaction feature. If there is a foreign transaction feature available in the list of payment instruments, then the transaction service 215 can select offer content 227 based at least in part on this context. For example, the offer content 227 can include an option (e.g., first option) for displaying information about a foreign transaction feature of an existing payment instrument 230 already associated with the purchasing user. Another option (e.g., third option) of offer content 227 can include information about delivery foreign currency to a residence mailing address of the recipient user of the international travel event.

If there is not a foreign transaction feature available in the list of payment instruments, then the transaction service 215 can select offer content 227 based at least in part on this context. For example, the offer content 227 can include an option (e.g., option two) for displaying information about a payment instrument 230 as a temporary add on feature to an existing payment instrument 230 or information on a supplemental payment instrument 230. Another option (e.g., third option) of offer content 227 can include information about delivery foreign currency to a residence mailing address of the traveler of the international travel trip.

At block 618, the transaction service 215 can transmit a notification to the client device 103 based at least in part on the selected offer content 227. The notification can include the offer content 227 and transaction confirmation data (e.g., purchasing confirmation data for the foreign travel event). Then, the transaction service 215 can proceed to the end, which can equate to waiting for an offer response as described in FIG. 5 (514).

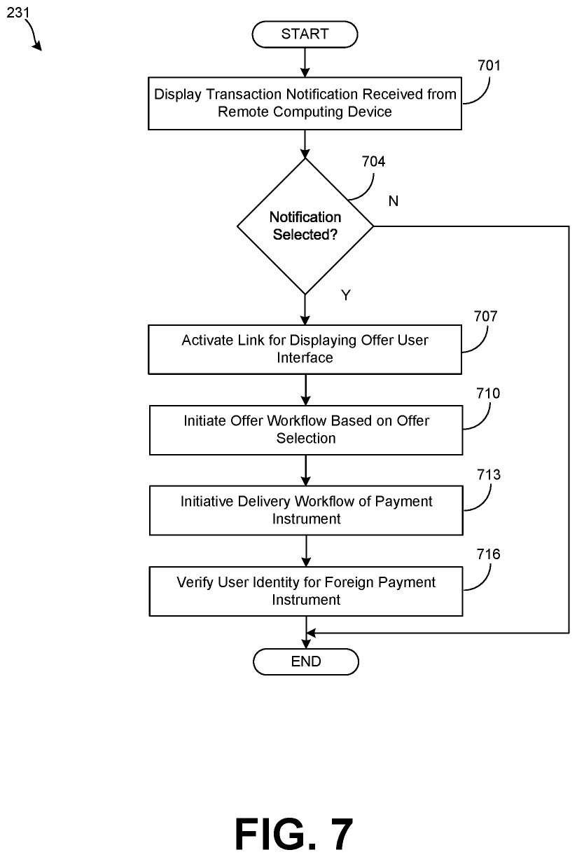

Referring next to FIG. 7, shown is a flowchart that provides one example of the operation of a portion of the client application 231 for a purchasing user of a foreign travel transaction. The flowchart of FIG. 7 provides merely an example of the many different types of functional arrangements that can be employed to implement the operation of the depicted portion of the client application 231. As an alternative, the flowchart of FIG. 7 can be viewed as depicting an example of elements of a method implemented within the network environment 200.

Beginning with block 701, the client application 231 can display a notification in a display of the client device 103 based at least in part on data received from the transaction service 215. In some examples, the data received has been filtered offer content 227 by the transaction service 215 based at least in part on a purchasing context associated with purchasing user. For example, the purchasing context can include whether the purchasing user is a traveler, whether the purchasing user has a foreign transaction feature on an existing payment instruments 230, and other suitable conditions. In some examples, the notification can be displayed as a push notification, a SMS message, an email, and other suitable formats.

At block 704, the client application 231 can determine whether the notification has been selected. If the notification is not selected within the threshold time period, then the client application 231 can be proceed to the end. If the notification is selected, then the client application 231 can proceed to block 707. In some examples, the notification includes a hyperlink, a deep link or another suitable mechanism for initiating an offer workflow by the client application 231.

At block 707, the client application 231 can activate a link associated with the notification. In some examples, the activation can include activating a deep link associated with the notification and the activation of the deep link can advance the client application 231 to an offer user interface. Additionally, the deep link can include one or more parameters embedded into the deep link. The embedded parameters can be used to pre-populate data (e.g., name, mailing address, email address, phone number, etc.) into the offer user interface. For example, when the offer user interface 109 is displayed, the client application 231 can enter the pre-populated data into certain data element fields in the offer user interface 109.

At block 710, the client application 231 can initiate an offer workflow based at least in part on the offer selection. The offer workflow can display offer user interface on the client device 103 for the purchasing user to enter requested data. For example, if the payment instrument 230 is for other users, the offer user interface can allow the entry of information related to the other users, which can subsequently be stored in user identities 242.

Additionally, the offer user interfaces can be displayed for the entry of payment instruments for the foreign payment instrument, such as a start date, an expiration date, category purchase restrictions, a total purchasing limit, geographical purchasing territories, and other suitable restrictions.

At block 713, the client application 231 can initiate a delivery workflow for delivering the payment instrument 230 to the recipient user (e.g., purchasing user, other users, etc.). In some examples, the payment instrument 230 can be delivered digitally, via mail courier, via personal courier, or other delivery methods after the offer workflow has been completed.

In other examples, the client application 231 can participate in a credential registration for an enhanced security for the delivery of the payment instrument 230. The credential registration can involve providing registration information to an issuer system. If the recipient user is the purchasing user, then the first client device 103a can provide the information. If the recipient user is another user, then the second client device 103b can provide the information. In response to having provided the information, the client device 103 can receive from the issue system a verifiable credential 236. The client application 231 can store the verifiable credential 236 in the client data store 243.

At block 716, the client application 231 can verify the recipient user to a verifier system. In response to verifying the recipient user, the client application 231 can receive a payment instrument 230 from the verifier system, a delivery agent, or other suitable entity. Then, the client application 231 can proceed to the end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The sequence diagram FIG. 3 and flowcharts FIGS. 4A, 4B, and 5-7 can show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence diagram FIG. 3 and flowcharts FIGS. 4A, 4B, and 5-7 show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagram FIG. 3 and flowcharts FIGS. 4A, 4B, and 5-7 can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 200.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
receive transaction data associated with a user profile, the user profile being associated with a device identifier of a client device;
identify a transaction in the transaction data based at least in part on an eligibility criterion, the eligibility criterion being used to identify that the transaction is for a foreign travel event that includes transporting a traveler from a first country to a second country;
retrieve traveler data associated with the transaction from a travel computing system based at least in part on a network identifier associated with the travel computing system;
generate offer content based at least in part on a comparison between the traveler data and the user profile; and
transmit a notification to the client device associated with the device identifier based at least in part on the offer content generated, the notification comprising the offer content and the transaction data.

2. The system of claim 1, wherein retrieving the traveler data associated with the transaction further causes the computing device to at least:
identify a merchant identifier in the transaction data;
determine the network identifier based at least in part on the merchant identifier; and
transmit a data request to the travel computing device based at least in part on the network identifier.

3. The system of claim 1, wherein generating the offer content comprises generating a deep link for a user interface of an application executed on the client device.

4. The system of claim 3, wherein the deep link comprises user data, wherein upon activation of the deep link, the user data is prepopulated into the user interface when displayed on the client device.

5. The system of claim 1, wherein machine-readable instructions stored in the memory that, when executed by the processor, cause the computing device to at least:
receive an acceptance of the offer content from the client device;
transmit to the client device a user interface for receiving a set of payment restrictions for a supplemental payment instrument; and
generate the supplemental payment instrument to be associated with a payment instrument of the user account.

6. The system of claim 5, wherein the machine-readable instructions stored in the memory that, when executed by the processor, cause the computing device to at least:
initiate a delivery of the supplemental payment instrument to a recipient user by initiating a registration of the recipient user for storing a recipient user identity; and
issue a verifiable credential for a decentralized identifier assigned to the recipient user identity; and
store the verifiable credential with a distributed ledger.

7. The system of claim 5, wherein the supplemental payment instrument is a digital payment instrument or a physical payment card.

8. A method, comprising:
receiving, by a computing device, transaction data associated with a user profile;
identifying, by the computing device, a transaction in the transaction data based at least in part on an eligibility criterion, the eligibility criterion being used to identify that the transaction is for a foreign travel event that includes transporting a traveler from a first country to a second country;
retrieving, by the computing device, traveler data associated with the transaction from a travel computing system based at least in part on a network identifier associated with the travel computing system;
generating, by the computing device, offer content based at least in part on a comparison between the traveler data and the user profile; and
transmitting, by the computing device, a notification to a client device associated with the user profile based at least in part on the offer content generated, the notification comprising the offer content and the transaction data.

9. The method of claim 8, wherein retrieving the traveler data associated with the transaction further comprises:
identifying, by the computing device, a merchant identifier in the transaction data;
determining, by the computing device, the network identifier based a least in part on the merchant identifier; and
transmitting, by the computing device, a data request to the travel computing device based at least in part on the network identifier.

10. The method of claim 8, wherein generating the offer content comprises generating a deep link for a user interface of an application executed on the client device.

11. The method of claim 10, wherein the deep link comprises user data, wherein upon activation of the deep link, the user data is prepopulated into the user interface when displayed on the client device.

12. The method of claim 8, further comprising:
receiving, by the computing device, an acceptance of the offer content from the client device;
transmitting, by the computing device, to the client device a user interface for receiving a set of payment restrictions for a supplemental payment instrument; and
generating, by the computing device, the supplemental payment instrument to be associated with a payment instrument of the user profile.

13. The method of claim 12, further comprising:
initiating, by the computing device, a delivery of the supplemental payment instrument to a recipient user by initiating a registration of the recipient user for storing a recipient user identity;
issuing, by the computing device, a verifiable credential for a decentralized identifier assigned to the recipient user identity; and
storing, by the computing device, the verifiable credential with a distributed ledger.

14. The method of claim 12, wherein the supplemental payment instrument is a digital payment instrument or a physical payment card.

15. A system, comprising:
a client device comprising a processor and a memory; and
machine-readable instructions stored in the memory that, when executed by the processor, cause the computing device to at least:
display a transaction notification based at least in part on data received from a remote computing device, the transaction notification comprising offer content for a user profile and a deep link for an application executed on the client device, the deep link comprising a reference parameter associated with the offer content;
display a user interface associated with the application based at least in part on a selection of the deep link and the reference parameter associated with the deep link;
receive a set of restrictions for a supplemental payment instrument from the user interface, the supplemental payment instrument being associated with a payment instrument for the user profile; and
initiate a delivery workflow of the supplemental payment instrument to a recipient user based at least in part on the set of restrictions, the supplemental payment instrument being eligible for executing purchases in at least two geographic territories.

16. The system of claim 15, wherein initiating the delivery workflow further causes the computing device to at least:
initiate a decentralized identifier registration for the recipient user with an issuer system; and
receive a verifiable credential for a decentralized identifier associated with the recipient user from the issuer system.

17. The system of claim 16, wherein machine-readable instructions stored in the memory that, when executed by the processor, cause the computing device to at least:
retrieve the supplemental payment instrument from a verifier system based at least in part on the verifiable credential; and
store the supplemental payment instrument in the memory of the client device.

18. The system of claim 15, wherein the reference parameter is embedded in the deep link.

19. The system of claim 15, wherein the transaction notification is a push notification from the remote computing device.

20. The system of claim 15, wherein the reference parameter indicates a user identifier, wherein the user interface includes the user identifier.
